(19) United States
(12) Patent Application Publication
(10) Pub. No.: US 2014/0344829 A1
(43) Pub. Date: Nov. 20, 2014

(54) DATA PROCESSING METHOD OF SHARED RESOURCE ALLOCATED TO MULTI-CORE PROCESSOR, ELECTRONIC APPARATUS WITH MULTI-CORE PROCESSOR AND DATA OUTPUT APPARATUS

(71) Applicant: SAMSUNG ELECTRONICS CO., LTD., Suwon-si (KR)

(72) Inventors: Byeong-hu LEE, Hwaseong-si (KR); Taek-gyun Kim, Suwon-si (KR); Hyoung-nam Kim, Suwon-si (KR); Yong-hee Park, Suwon-si (KR); Jong-jik Lee, Suwon-si (KR)

(73) Assignee: SAMSUNG ELECTRONICS CO., LTD., Suwon-si (KR)

(21) Appl. No.: 14/274,820

(22) Filed: May 12, 2014

(30) Foreign Application Priority Data
May 14, 2013 (KR) 10-2013-0054424

(51) Int. Cl. G06F 9/50

(52) U.S. Cl. CPC G06F 9/5005
USPC 718/104

(57) ABSTRACT

A data processing method is a shared resource which is allocated to a multi-core processor includes receiving a first data stream from a first processor, when a second data stream is received from a second processor before processing of the first data stream is complete, locating the second data stream in front of a data stream which is on standby from among the first data stream, and processing the located second data stream and the first data stream on standby in sequence.

### CROSS-REFERENCE TO RELATED APPLICATIONS

This application claims priority benefit from Korean Patent Application No. 10-2013-0054424, filed on May 14, 2013, in the Korean Intellectual Property Office, the disclosure of which is incorporated herein by reference in its entirety.

### BACKGROUND

1. Field

The following description relates to a data processing method of a resource allocated to a multi-core processor, and more particularly, to a data processing method of a shared resource allocated to a multi-core processor, an electronic apparatus including a multi-core processor, and a data output apparatus.

2. Description of the Related Art

The performance of processors of related-art electronic apparatuses is improved by increasing clock speed. However, if the speed increases, power consumption and heat increase so that the processor reaches the limit of speedup. Since a multi-core processor, which is suggested as an alternative, includes multiple cores, respective cores may operate in lower frequency and power consumed by a single core may be dispersed to the multiple cores. In addition, the multi-core processor enables parallel processing of the process. Accordingly, since fast data processing is capable compared with a single-core processor, the multi-core processor is effective when performing a job having a large amount of overhead such as encoding of video or game.

Consequently, recent embedded systems generally use a multi-core processor including two or more processors. Due to this structure, power consumption and inefficient increase of hardware may be reduced, and efficient operation may be enabled by processing as many as threads of the number of processors at the same time

However, in a system having a multi-core processor, a cache of the system, an adjacent memory, and a storage device are shared by the multiple processors and may not be used at the same time. For these shared resources, threads executed by the multiple processors may receive permissions for use in a predetermined order. Accordingly, when requests for use of the resources are gathered from multiple threads, data processing may be delayed. For example, delay of data processing in the case of standard output of an operating system will be described below.

Software developers of embedded systems use a standard output module which is supported by an operating system in order to analyze and solve a problem which occurs when developing software of the embedded system, or a problem which occurs in a manufactured product by the user. The standard output module performs output by recording a log for the state of the system. In addition, the standard output may be output as serial data, or may be transmitted to other devices through Ethernet, for example. The standard output is effectively used to develop or modify software.

FIG. 1 is a mimetic diagram showing a data processing state when an operating system of a multi-core processor in a related art performs standard output.

FIG. 1 shows that threads 11, 12, . . . , and 13 of a plurality of core processors 0, 1, . . . , and N use a standard output module. As shown in FIG. 1, different threads may approach a software block in charge of standard output 14. In order to solve problems such as monopoly of resource and simultaneous approach which may occur by sharing of the plurality of threads, an operating system allows limited approach to the shared resource.

The operating system processes data by allocating the resource in the requested order. Accordingly, a thread which makes a first request uses the standard output module preferentially. When the operating system allows any thread 11 to use the standard output, the operating system stands by the use of the standard output of other threads 12 and 13. A thread of which approach is postponed is locked and postpones operation until the thread which monopolizes the resource finishes the use of the standard output. When a plurality of threads requests the standard output, the operating system repeatedly locks or unlocks the standard output of each thread.

In a data processing method of the shared resource of the related-art multi-core processor, as the requests for the use of the shared resource increase, a thread which makes a later request has a longer standby time. In addition, as the number of cores embedded in the processor increases, the standby time of a later thread increases. Therefore, there is a need for a system to efficiently process data by reducing an average standby time of processes which use a shared resource.

### SUMMARY

Exemplary embodiments of the present disclosure overcome the above disadvantages and other disadvantages not described above. Also, the present disclosure is not required to overcome the disadvantages described above, and an exemplary embodiment of the present disclosure may not overcome any of the problems described above.

The present disclosure provides a data processing method of a shared resource allocated to a multi-core processor which is capable of efficiently processing data throughout a system by reducing an average standby time of processes which use the shared resource when the multi-core processor shares the single resource, an electronic apparatus including the multi-core processor, and a data output apparatus.

According to an aspect of the present disclosure, a data processing method of a shared resource which is allocated to a multi-core processor includes receiving a first data stream from a first processor, when a second data stream is received from a second processor before processing of the first data stream is complete, locating the second data stream in front of a data stream which is on standby from among the first data stream, and processing the located second data stream and the first data stream on standby in sequence. When a second data stream is not received from the second processor before processing of the first data stream is complete, the first data stream is processed sequentially without any interrupt.

The data processing method may further include when the first data stream is received from the first processor, adding a first identifier to the first data stream. In the operation of locating the second data stream, when the second data stream is received before processing of the first data stream is complete, a second identifier may be added to the second data stream and the first identifier may be added to the first data stream on standby.

The data processing method may further include adding an end identifier to ends of the first data stream and the second data stream.

The shared resource allocated to the multi-core processor may be a standard output module.

In the operation of processing the data stream, serial output may be performed to an external device.

The first data stream and the second data stream may be received from a thread of the first processor and a thread of the second processor, respectively.

When an electronic apparatus requests data processing, there may be a separate data processing apparatus. In this case, a data processing method of the data processing apparatus which is allocated to a multi-core processor includes receiving a data stream in which a first data stream of a first processor and a second data stream of a second processor are mixed, and parsing the mixed data stream, and separating and outputting the first data stream and the second data stream according to the processors.

The first data stream and the second data stream may be received from a thread of the first processor and a thread of the second processor, respectively.

According to another aspect of the present disclosure, an electronic apparatus including a multi-core processor includes a first processor, a second processor, and a data processing module configured to be shared by the first processor and the second processor, and to process a first data stream and a second data stream which are received from the first processor and the second processor respectively, wherein when the data processing module receives the second data stream before completing processing of the received first data stream, the data processing module locates the second data stream in front of a data stream which is on standby from among the first data stream.

When the data processing module receives the first data stream from the first processor, the data processing module may add a first identifier to the first data stream, and when the data processing module receives the second data stream before completing processing of the first data stream, the data processing module may add a second identifier to the second data stream and add the first identifier is added to the first data stream on standby.

The data processing module may add an end identifier to ends of the first data stream and the second data stream.

A shared resource allocated to the multi-core processor may be a standard output module.

The data processing module may perform serial output to an external device.

The first data stream and the second data stream may be received from a thread of the first processor and a thread of the second processor, respectively.

According to yet another aspect of the present disclosure, a data processing apparatus includes a receiver configured to receive a data stream in which a first data stream and a second data stream of a first processor and a second processor which are included in an electronic apparatus including a multi-core processor are mixed, and an output unit configured to parse the mixed data stream, and separate and output the first data stream and the second data stream according to the processors.

The first data stream and the second data stream may be received from a thread of the first processor and a thread of the second processor, respectively.

According to the diverse exemplary embodiments of the present disclosure, when the multi-core processor shares a single resource, an average standby time of processes which use the shared resource is reduced so that data can be processed efficiently throughout the system.

Additional and/or other aspects and advantages of the disclosure will be set forth in part in the description which follows and, in part, will be obvious from the description, or may be learned by practice of the disclosure.

### BRIEF DESCRIPTION OF THE DRAWINGS

The above and/or other aspects of the present disclosure will be more apparent by describing certain exemplary embodiments of the present disclosure with reference to the accompanying drawings, in which:

FIG. 1 is a mimetic diagram showing a data processing state when an operating system of a multi-core processor in a related art performs standard output;

FIG. 2 is a mimetic diagram showing operation of standard output which is allocated to a multi-core processor according to an exemplary embodiment of the present disclosure;

FIG. 3 is a block diagram of a configuration of an electronic apparatus including a multi-core processor according to an exemplary embodiment of the present disclosure;

FIG. 4 is a mimetic diagram showing processing of standard output of the electronic apparatus according to an exemplary embodiment of the present disclosure;

FIG. 5 is a mimetic diagram showing a process of generating a system log by a client which receives rearranged character strings; and

FIG. 6 is a flow chart of a data processing method according to diverse exemplary embodiments of the present disclosure.

### DETAILED DESCRIPTION

Embodiments of the present disclosure will now be described in greater detail with reference to the accompanying drawings.

In the following description, same drawing reference numerals are used for the same elements even in different drawings. The matters defined in the description, such as detailed construction and components, are provided to assist in a comprehensive understanding of the disclosure. Thus, it is apparent that the exemplary embodiments of the present disclosure may be carried out without those specifically defined matters. Also, well-known functions or constructions are not described in detail since they would obscure the disclosure with unnecessary detail.

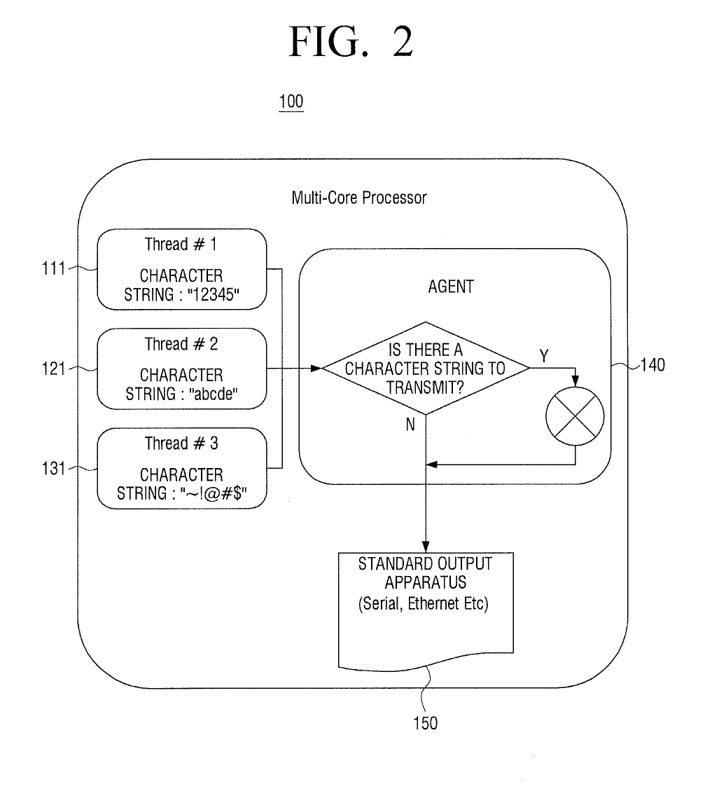

FIG. 2 is a mimetic diagram showing operation of a standard output system 100 which performs standard output allocated to a multi-core processor according to an exemplary embodiment of the present disclosure.

As shown in FIG. 2, a thread of each processor which constitutes the multi-core processor may request standard output. In FIG. 2, Thread #1 (111) transmits a character string, “12345”, Thread #2 (121) transmits a character string, “abcde”, and Thread #3 (131) transmits a character string, “˜!@#$”.

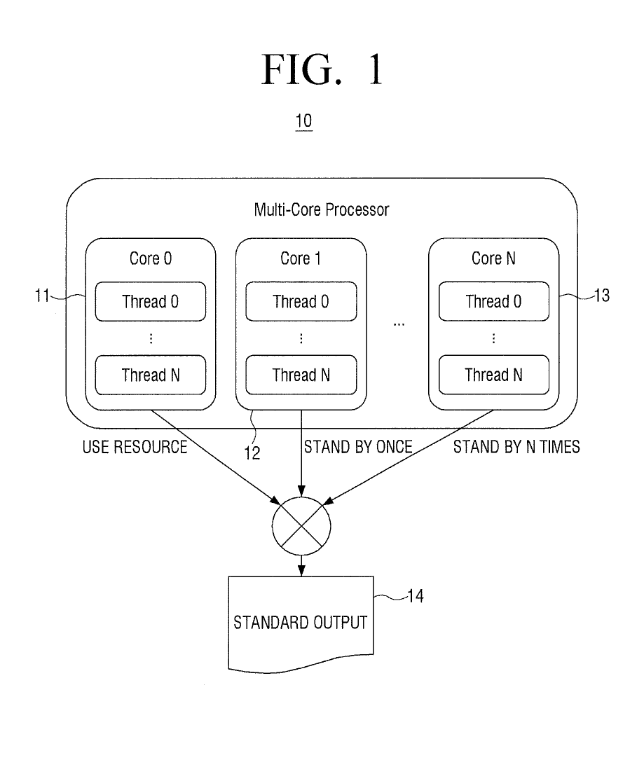

As shown in FIG. 1, in the related art, when the plurality of threads 11, 12 and 13 request standard output, and the standard output apparatus 14 operates in the requested order, a single thread uses the standard output apparatus 14 and other threads stand by. In this system, after a data stream of the thread which is using the standard output apparatus 14 is completely processed, a data stream of a subsequent thread on standby is processed. In this case, the operating system only allows limited approach to the shared resource in order to prevent monopoly of the resource and simultaneous approach which may occur by sharing of the plurality of threads. A thread of which approach is postponed is locked and postpones operation until the thread which monopolizes the resource finishes the use of the standard output or the resource is released by the thread. When a plurality of threads requests the standard output, the operating system repeatedly locks or unlocks the standard output of each thread.

However, in the aforementioned data processing method of the shared resource of the related-art multi-core processor, as the requests for the use of the shared resource increase, a thread which makes a later request has a longer standby time. For example, if the threads #1, #2 and #3 (111, 121 and 131) shown in FIG. 2, are executed by the related-art multi-core processor, in order to perform standard output of the character string “abcde”, Thread #2 (121) may wait until standard output of the character string “12345” of Thread #1 (111) is complete. In addition, in order to perform standard output of the character string “˜!@#$”, Thread #3 (131) may wait until the standard output of the character string “12345” of Thread #1 (111) and the standard output of the character string “abcde” of Thread #2 (121) are complete.

The exemplary embodiment of the present disclosure suggests a method to solve this problem. The exemplary embodiment of the present disclosure includes an agent 140 (which is used as the same term as a data processing module in a later exemplary embodiment) which may distribute permissions for use of the shared resource. When a thread requests standard output, the agent 140 checks whether there is a running standard output. When there is no running standard output, the newly requested job of the thread is performed first. However, when there is a running standard output, a priority order of the existing job and the new job is determined according to a predetermined priority order. This is described in greater detail later.

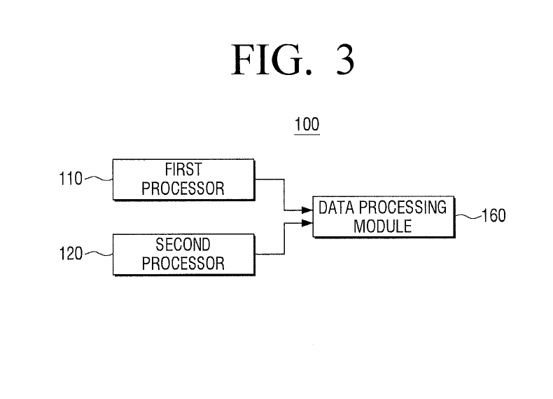

FIG. 3 is a block diagram of a configuration of an electronic apparatus 100 including a multi-core processor according to an exemplary embodiment of the present disclosure.

With reference to FIG. 3, the electronic apparatus 100 according to an exemplary embodiment of the present disclosure may include a first processor 110 and a second processor 120 which constitute a multi-core processor, and a data processing module 160.

The processor indicates an independent module which is capable of processing data. The processor may include a central processing unit (CPU) or a micro processing unit (MPU), a cache memory, and a bus in terms of hardware. The processor reads out data stored in a random-access memory (RAM) or an auxiliary memory to the cache memory, and decodes and operates the data in the cache memory. In general, a single CPU includes a plurality of cache memories to minimize a delay which is caused by difference of access speeds of memories.

The speed of the CPU is expressed as a “clock” which may be indicated as a frequency unit, “Hz”, by measuring how many steps of operation are processed per a second in the CPU. Accordingly, as the numerical value of the clock increases, the CPU is determined to be a high-performance CPU. However, if the speed of the clock increases simply, power consumption and heat increase so that there may be a limit to speedup. Accordingly, a multi-core processor having a plurality of core processors is generally used. In the multi-core processor, individual cores may operate in a lower frequency and power consumed by a single core is dispersed to the multiple cores. In addition, since the multi-core processor enables parallel processing of the process, fast data processing is capable compared with a single-core processor. Therefore, the multi-core processor is effective when performing a job having a large amount of overhead such as encoding of video or game.

The electronic apparatus 100 according to the exemplary embodiment of the present disclosure also includes a multi-core processor. In other words, the electronic apparatus 100 includes at least two processors, the first processor 110 and the second processor 120.

An operating system of the electronic apparatus 100 controls operation of the first processor 110 and the second processor 120 separately according to a system call. The operating system may allocate a different process to the first processor 110 and the second processor 120. Alternatively, in a single process, the operating system may allocate a different thread to each processor. When the multi-core processor needs complex operation, the plurality of processors process data in parallel so that data processing may become much faster. However, there may be a problem when a single resource has to be shared by the plurality of processors. When a single processor occupies a resource first as described above, other processors have to wait until a job of the first occupying processor is complete.

In order to solve this problem, the electronic apparatus 100 according to an exemplary embodiment of the present disclosure includes the data processing module 160 which is shared by the first processor 110 and the second processor 120 and which processes a first data stream and a second data stream received from the first processor 110 and the second processor 120 respectively.

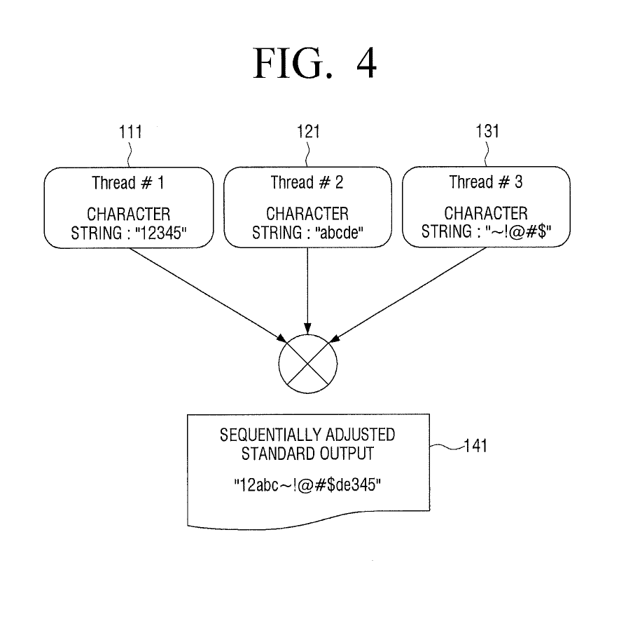

When the data processing module 160 receives the second data stream before completing processing of the first data stream, the data processing module 160 processes the data by locating the second data stream in front of a data stream on standby from among the first data stream. Detailed operation of the data processing module 160 is described with reference to example of standard output as shown in FIG. 4.

FIG. 4 is a mimetic diagram showing processing of standard output of the electronic apparatus 100 according to an exemplary embodiment of the present disclosure.

With reference to FIG. 4, when the data processing module 160 receives requests for processing data from a plurality of threads, the data processing module 160 does not process the data in the requested order but processes the data in a predetermined priority order. That is, in the exemplary embodiment as shown in FIG. 4, let's suppose that a data stream of Thread #1 (111) is “12345”, Thread #1 (111) requests data processing first, and Thread #2 (121) requests processing of a data stream, “abcde”. If Thread #2 (121) is ahead of Thread #1 (111) in the priority order, the data processing module 160 locates the data stream of Thread #2 (121) in front of the data stream of Thread #1 (111). If “abcde” of data stream of Thread #2 (121) is received while “12” from among the data stream of Thread #1 (111) is processed, the final data processing order becomes “12abcde345”. In addition, let's suppose that a request for processing “˜!@#$” of data stream of Thread #3 (131) is received while “abc” from among the data stream of Thread #2 (121) is processed. If Thread #3 (131) is the highest in the processing priority order, the final data processing order becomes “12abc˜!@#$de345” since interrupt of data processing order occurs in the priority order.

If a shared resource is a standard output apparatus, output of character strings requested by a plurality of threads is given identifiers (ID) indicating a beginning and an end at the very front and very end characters in the requested order by the standard output agent (refer to reference number 140 of FIG. 2). If the standard output agent 140 receives a request from another thread while transmitting a character string, which has received the identifiers, through standard output, the standard output agent 140 adds the identifier of the currently output character string to the front of a character which is currently on standby, gives identifiers to a newly requested character string, and locates the newly requested character string in front of the currently output character string. Also, character strings which are newly requested from other threads receives identifiers in the same manner and are added to the very front of the currently output character string. Consequently, the problem of locking other threads and slowing down the performance until output of a character string requested by a thread is complete may be reduced.

FIG. 4 shows an example in which the standard output agent 140 arranges character strings asynchronously at the output requests of Threads #1 to #3. In FIG. 4, Thread #1 (111) requests output of a character string “12345”, and the standard output agent receives a request for output of “abcde” from Thread #2 while transmitting the character string “12345” and finally outputs a character string “12abc˜!@#$de345” in the method proposed in the exemplary embodiment of the present disclosure.

The reason why a later requested character string is located at the very front of a currently transmitted character string is that it is advantageous for a client receiving the character string to allocate sequential time information (time stamp) to the character strings processed by the multi-core processor using the first character of the firstly received character string.

The client which receives the standard output transmitted from the multi-core processor rearranges each character string using known identifiers and generates a system log. For example, let us supposes that in a Linux system which supports Unicode of UTG-8 format, an identifier to designate each character string is “<0xFFFF+index>”, and an identifier to indicate the end of each character string is “<0xFFFF+0xFF>”. The transmitted character string shown in FIG. 4 may be expressed as below.

“<FFFF01>12<FFFF02>abc<FFFF03>˜!@#$<FFFFFF><FFFF02>de<FFFFFF><FFF F01>345<FFFFFF>”

Herein, a beginning identifier indicated as “<0xFFFF+index>” gives an index to combine character strings to a character string “0xFFFF” which does not exist in the UTF-8 format, and thus shows that the same character string is being received until an end identifier “<0xFFFF+0xFF>” to indicate the end of the current character string is received. Here, a value in “< >” is expressed as a character string, but may be an actual HEX value.

The client receives the rearranged character strings from the standard output agent 140, and rearranges each character string using “<0xFFFF+index>” and “<0xFFFF+0xFF>”.

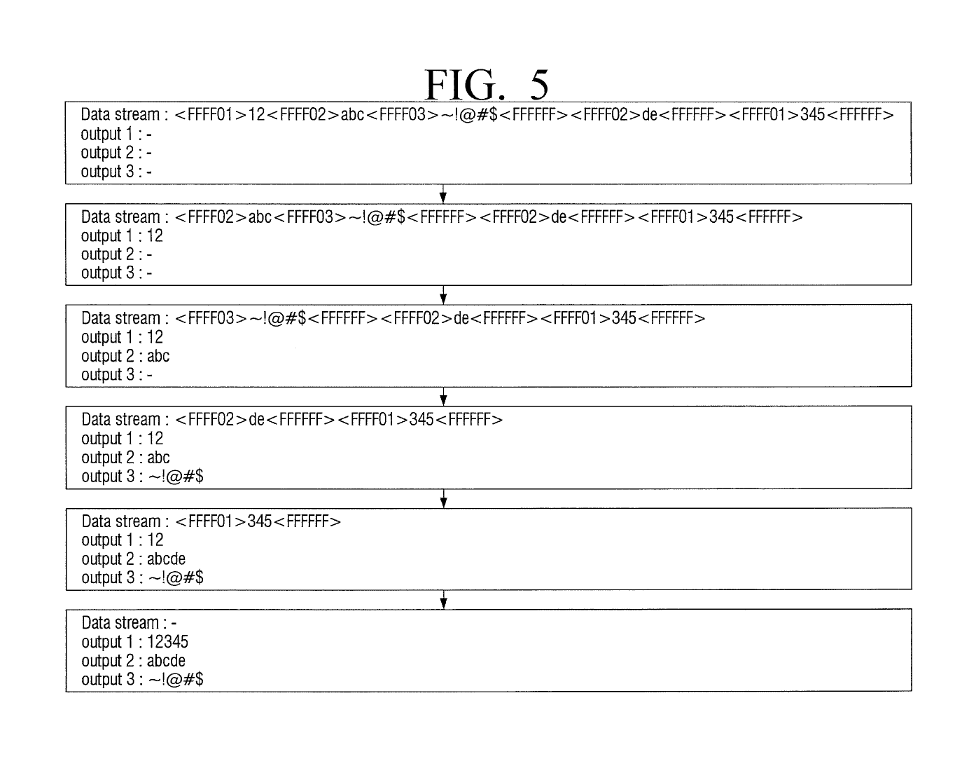

FIG. 5 is a mimetic diagram showing a process of generating a system log by the client which receives the rearranged character strings.

As shown in FIG. 5, the client recognizes the beginning of a first data stream using a beginning identifier indicating the first data stream, removes the beginning identifier, and stores the first data stream in a first log (Output 1). Similarly, when a beginning identifier indicating a second data stream is parsed, the client recognizes the beginning of the second data stream, removes the beginning identifier, and stores the second data stream in a second log (Output 2). When the client meets an end identifier in the sequential parsing process, the client recognizes the end of a data stream which is located in front of the end identifier, closes a corresponding log, and discards the end identifier. The client may gain system information that it wants by rearranging and restoring the received character strings using the beginning identifiers and the end identifiers.

The aforementioned electronic apparatus 100 has a structure which is similar to that of a general computer. In other words, the electronic apparatus 100 may include a main memory, an auxiliary memory, a graphic module, a sound module, a wired/wireless communication module, a display, and an input unit. Since these components are not related to the main idea of the present disclosure, detailed description is omitted.

A data processing method according to diverse exemplary embodiments is described below.

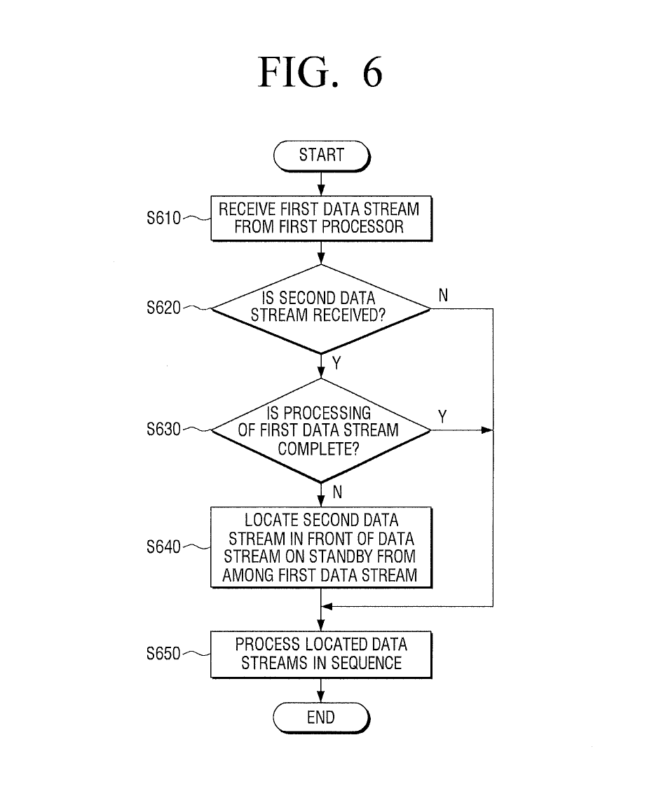

FIG. 6 is a flow chart of a data processing method according to diverse exemplary embodiments of the present disclosure.

With reference to FIG. 6, the data processing method according to diverse exemplary embodiments of the present disclosure may include receiving a first data stream from a first processor (S610), determining whether a second data stream is received from a second processor (S620), determining whether the received second data is received while the first data stream is processing or before the first data stream is complete (S630), locating a second data stream in front of a data stream on standby from among the first data stream if the second data stream is received from a second processor before processing of the received first data stream is complete or during the processing of the first data stream (S640), and processing the located second data stream and the first data stream on standby in sequence (S650). If the second data stream is not received after processing of the received first data stream is complete, the first data stream is processed sequentially without any interrupt.

In addition, the data processing method may further include adding a first identifier to the first data stream when the first data stream is received from the first processor. In the locating of the received second data stream (S640), when the second data stream is received before the processing of the first data stream is complete, a second identifier is added to the second data stream and the first identifier is added to the data stream on standby.

In addition, the data processing method may further include adding an end identifier to the end of the first data stream and the second data stream.

In addition, a shared resource allocated to the multi-core processor may be a standard output module.

In addition, in the aforementioned data stream processing operation (S650), the serial output may be output to an external device.

Furthermore, the first data stream and the second data stream may be received from a thread of the first processor and a thread of the second processor, respectively.

If the electronic apparatus 100 requests data processing, there may be a separate data processing apparatus. In this case, a data processing method of the data processing apparatus may include receiving a data stream in which the first data stream of the first processor and the second data stream of the second processor are mixed, parsing the mixed data stream, and separating and outputting the first data stream and the second data stream according to each processor.

The first data stream and the second data stream may be received from the thread of the first processor and the thread of the second processor, respectively.

The above-described embodiments may be recorded in non-transitory computer-readable media including program instructions to implement various operations embodied by a computer. The non-transitory computer readable medium may be a medium which does not store data temporarily such as a register, cash, and memory but stores data semi-permanently and is readable by electronic apparatuses. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD ROM disks, DVDs and Blu-rays ; magneto-optical media such as optical discs; and hardware devices that are specially configured to store and perform program instructions, such as read-only memory (ROM), random access memory (RAM), flash memory, and the like. The computer-readable media may also be a distributed network, so that the program instructions are stored and executed in a distributed fashion. The program instructions may be executed by one or more processors. The computer-readable media may also be embodied in at least one application specific integrated circuit (ASIC) or Field Programmable Gate Array (FPGA), which executes (processes like a processor) program instructions. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

Furthermore, the aforementioned data processing method may be embedded in hardware integrated circuit (IC) chip or may be provided as firmware.

According to the diverse exemplary embodiments of the present disclosure, when the multi-core processor shares a single resource, an average standby time of processes which use the shared resource is reduced so that data can be processed efficiently throughout the system.

The foregoing exemplary embodiments and advantages are merely exemplary and are not to be construed as limiting the present disclosure. The present teaching can be readily applied to other types of apparatuses. Also, the description of the exemplary embodiments of the present disclosure is intended to be illustrative, and not to limit the scope of the claims, and many alternatives, modifications, and variations will be apparent to those skilled in the art.

1. A data processing method of a shared resource which is allocated to a multi-core processor, the method comprising:
receiving a first data stream from at least one of first and second processors;
receiving a second data stream from at least one of the first and second processors;
when the second data stream is received before processing of the first data stream is complete, locating the second data stream in front of a data stream which is on standby from among the first data stream; and
processing the located second data stream and the first data stream on standby in sequence.

2. The data processing method as claimed in claim 1, further comprising:
when the first data stream is received, adding a first identifier to the first data stream,
wherein in the locating of the second data stream, when the second data stream is received before processing of the first data stream is complete, a second identifier is added to the second data stream and the first identifier is added to the first data stream on standby.

3. The data processing method as claimed in claim 1, further comprising:
adding an end identifier to ends of the first data stream and the second data stream.

4. The data processing method as claimed in claim 1, wherein the shared resource allocated to the multi-core processor is a standard output module.

5. The data processing method as claimed in claim 1, wherein in the processing of the data stream, serial output is performed to an external device.

6. The data processing method as claimed in claim 1, wherein the first data stream and the second data stream are received from a thread of the at least one of the first processor and the second processor, respectively.

7. A data processing method of a shared resource which is allocated to a multi-core processor, the method comprising:
receiving a data stream in which a first data stream of a first processor and a second data stream of a second processor are mixed; and
parsing the mixed data stream, and separating and outputting the first data stream and the second data stream according to the processors.

8. The data processing method as claimed in claim 7, wherein the first data stream and the second data stream are received from a thread of the first processor and the second processor, respectively.

9. An electronic apparatus including a multi-core processor, the electronic apparatus comprising:
a first processor;
a second processor; and
a data processing module configured to process a first data stream and a second data stream which are received from at least one of the first processor and the second processor,
wherein when the data processing module receives the second data stream before completing processing of the received first data stream, the data processing module locates the second data stream in front of a data stream which is on standby from among the first data stream.

10. The electronic apparatus as claimed in claim 9, wherein when the data processing module receives the first data stream, the data processing module adds a first identifier to the first data stream, and
when the data processing module receives the second data stream before completing processing of the first data stream, the data processing module adds a second identifier to the second data stream and adds the first identifier to the first data stream on standby.

11. The electronic apparatus as claimed in claim 9, wherein the data processing module adds an end identifier to ends of the first data stream and the second data stream.

12. The electronic apparatus as claimed in claim 9, wherein a shared resource allocated to the multi-core processor is a standard output module.

13. The electronic apparatus as claimed in claim 9, wherein the data processing module performs serial output to an external device.

14. The electronic apparatus as claimed in claim 9, wherein the first data stream and the second data stream are received from a thread of the at least one of the first processor and the second processor, respectively.

15. A data processing apparatus comprising:
a receiver configured to receive a data stream in which a first data stream and a second data stream of a first processor and a second processor which are included in an electronic apparatus comprising a multi-core processor are mixed; and
an output unit configured to parse the mixed data stream, and separate and output the first data stream and the second data stream according to the processors.

16. The data processing apparatus as claimed in claim 15, wherein the first data stream and the second data stream are received from a thread of the first processor and a thread of the second processor, respectively.

17. At least one non-transitory computer readable medium to store computer readable instruction to control at least one processor to implement the method of claim 1.

18. The data processing method as claimed in claim 1, wherein the first data stream is received from the first processor and the second data stream is received from the second processor.

19. The electronic apparatus as claimed in claim 9, wherein the data processing module is configured to be shared by the first processor and the second processor.

20. The electronic apparatus as claimed in claim 9, wherein the first data stream is received from the first processor and the second data stream is received from the second processor.

21. The data processing method as claimed in claim 1, wherein the second data stream is higher in a processing priority order than the first data stream.

22. The electronic apparatus as claimed in claim 9, wherein the second data stream is higher in a processing priority order than the first data stream.

23. The data processing method as claimed in claim 1, wherein the data processing module processes the first and second data streams according to a predetermined processing priority order.

24. The electronic apparatus as claimed in claim 9, wherein the data processing module processes the first and second data streams according to a predetermined processing priority order.

25. A data processing method of a shared resource which is allocated to a multi-core processor, the method comprising:
receiving a first data stream from at least one of a first and second processors;
receiving a second data stream from at least one of the first and second processors;
when the second data stream is received while processing the first data stream, processing the second data stream while putting the processing of the first data stream on standby; and
processing a remaining portion of the first data stream after completing the processing of the second data stream.

26. The data processing method as claimed in claim 25, wherein the first data stream and the second data stream are received from a thread of the at least one of the first processor and the second processor, respectively.

27. The data processing method as claimed in claim 26, wherein the first thread includes first character strings and the second thread includes second character strings.

28. The data processing method as claimed in claim 25, wherein the first data stream is received from the first processor and the second data stream is received from the second processor.

29. (canceled)

30. An electronic apparatus including a multi-core processor, the electronic apparatus comprising:
a first processor;
a second processor; and
a data processing module configured to process a first data stream and a second data stream which are received from at least one of the first processor and the second processor,
wherein when the data processing module receives the second data stream while processing the first data stream, the data processing module processes the second data stream while putting the processing of the first data stream on standby, and processes a remaining portion of the first data stream after completing the processing of the second data stream.

31. The electronic apparatus as claimed in claim 30, wherein the data processing module is configured to be shared by the first processor and the second processor.

32. The electronic apparatus as claimed in claim 30, wherein the first data stream and the second data stream are received from a thread of the at least one of the first processor and the second processor, respectively.

33. The electronic apparatus as claimed in claim 32, wherein the first thread includes first character strings and the second thread includes second character strings.

34. The electronic apparatus as claimed in claim 30, wherein the first data stream is received from the first processor and the second data stream is received from the second processor.

35. The electronic apparatus as claimed in claim 30, wherein the second data stream is higher in a processing priority order than the first data stream.

36. The data processing method as claimed in claim 25, wherein the second data stream is higher in a processing priority order than the first data stream.

37. At least one non-transitory computer readable medium to store computer readable instruction to control at least one processor to implement the method of claim 25.
